(19) United States
(12) Patent Application Publication
(10) Pub. No.: US 2026/0249768 A1
(43) Pub. Date: Aug. 27, 2026

(54) Hoisted, Stacked, Waste Container with Locking Dump Pivot, Low Profile Protective Feet and Alignment Members, and Filtering Drain and Method of Retrofitting the Same

(71) Applicant: Mighty Binz, LLC, Pittsburgh, PA (US)

(72) Inventors: Tom Milani, Pittsburgh, PA (US); Steve Milani, Pittsburgh, PA (US)

(21) Appl. No.: 19/548,874

(22) Filed: Feb. 24, 2026

Related U.S. Application Data
(60) Provisional application No. 63/762,113, filed on Feb. 24, 2025.

(51) Int. Cl. B60P 1/64; B60P 1/28; B65F 3/00; B65F 3/26

(52) U.S. Cl. CPC B60P 1/6409; B60P 1/28; B60P 1/6427; B65F 3/26; B65F 2003/008

(57) ABSTRACT

A hoisted waste container system includes a truck that delivers and retrieves containers having a hoist for delivering, retrieving and dumping the containers and a pair of stanchions; and a first container having a steel body including a pair of side walls, a front and rear end walls, and flooring, wherein rear end wall has hinges and a latching member to create a door; and a locking dump pivot comprising a pair of trunnions coupled to the side walls of the container configured to be received within a saddle in the pair of stanchions, wherein the locking dump pivot acts to secure the container to the truck and further acts as a pivot point for dumping of the container. A second stacked, waste container includes feet and alignment members for securing stacked containers together.

### RELATED APPLICATION

This application claims priority to United States provisional patent application Ser. No. 63/762,113 filed Feb. 24, 2025, titled “Hoisted, Stacked, Waste Container with Locking Dump Pivot, Low Profile Protective Feet and Alignment Members, and Filtering Drain and Method of Retrofitting the Same” which application is incorporated herein by reference in its entirety.

### BACKGROUND INFORMATION

### 1. Field of the invention

The present invention relates to truck delivered waste containers.

### 2. Background Information

The present invention relates truck transported waste containers and recycling containers, also known as dumpsters and bins. The terms “waste containers”, “recycling containers”, “dumpsters” and “bins” will be defined herein as solid walled containers, typically metal with a rectangular footprint. The waste container as a solid walled container is contrasted with flexible walled waste receptacles or “bags” that have been recently popular. Typically, waste containers are delivered and removed by an associated truck and/or emptied by an associated truck. Some other, generally more specific, terms used in the industry include a rolloff, lugger box, a front load container, roll-on/roll-off, roll-off box, and a rear load container. The terms wheelie-bin and skip or skip box are popular terms used outside the United States for some waste containers. Variations of all these terms are also known in the industry, with many terms being associated with a subset of the broader category, often based upon how it is loaded. All of these various terms, unless specified otherwise, are deemed roughly equivalent for this specification and may be used interchangeably within this specification.

The word “dumpster” was first used commercially in 1936, from the Dempster-Dumpster system of mechanically loading the contents of standardized containers onto garbage trucks, which was patented by Dempster Brothers in 1935 in U.S. Pat. No. 2,150,821, which is incorporated herein by reference. The containers were called Dumpsters, a blending of the company's name with the word dump. The Dempster Dumpmaster, which became the first successful front-loading garbage truck that used this system, popularized the word. Over time the trademark became a generic term for such containers.

In general, there are two categories of truck transported temporary or semi-temporary waste containers. The first are hook lift containers or hoisted bins which are delivered using hoist arm(s) extending from the truck to lift it and place it on the ground or to lift it from the ground to the truck. The second are roll-off bins which are delivered with wheels attached to a winch and cable system on an inclinable bed allowing the bin to roll off of and onto the truck.

One issue with truck transported waste containers of the prior art is marring the surface, such as asphalt or concrete, upon which they are placed. A large waste container, particularly roll off containers, can easily mar an asphalt surface upon which they are placed. The industry has taken some steps to minimize this damage. For example, the website Hometown Dumpster Rental website, directed to “How to Prevent (and Address) Driveway Dumpster Damage” by Hometown Dumpster Rental, postulates that having “plywood or boards placed underneath the steel dumpster feet is the best way to avoid driveway damage. Most dumpster rental companies will do this for you, but not all, so always ask before you hire. Using plywood beneath the steel feet or wheels of the dumpster provides a cushion between the dumpster and the driveway, preventing driveway scratches and cracks.” Hard impact resistant plastic sheets to prevent marring have also been utilized. These wood or plastic sheet solutions are time consuming which prevents their wide adoption.

Another issue with truck transported waste containers of the prior art is the time and equipment needed to have them adequately secured on the transporting truck. For example, 49 C.F.R. § 393.134 requires that each roll-on/roll-off and hook lift [hoisted] container carried on a vehicle which is not equipped with an integral securement system must be:
1. Blocked against forward movement by the lifting device, stops, a combination of both or other suitable restraint mechanism;
2. Secured to the front of the vehicle by the lifting device or other suitable restraint against lateral and vertical movement;
3. Secured to the rear of the vehicle with at least one of the following mechanisms:
   a) One tie-down attached to both the vehicle chassis and the container chassis;
   b) Two tie-downs installed lengthwise, each securing one side of the container to one of the vehicle's side rails; or
   c) Two hooks, or an equivalent mechanism, securing both sides of the container to the vehicle chassis at least as effectively as the tie-downs in the two previous items.
4. The mechanisms used to secure the rear end of a roll-on/roll off or hook lift container must be installed no more than two meters (6 ft 7 in) from the rear of the container.
5. (5) In the event that one or more of the front stops or lifting devices are missing, damaged or not compatible, additional manually installed tie-downs must be used to secure the container to the vehicle, providing the same level of securement as the missing, damaged or incompatible components.

There remains a need for integral securement systems for truck transported waste containers.

A further issue with truck transported waste containers of the prior art is the ability to easily empty the containers once loaded onto the truck and taken to a final disposal site. Creating waste containers that may be easily dumped improves efficiencies. There remains a need to provide efficient effective methods for emptying the waste containers.

A further issue with truck transported waste containers of the known art is handling rainwater. Rainwater will often drain from openings in the waste container. The openings may be intentional (e.g., weep holes), spaces in a door closing that are not water tight, fastener holes, or holes from container damage and/or wear. State and federal agencies are concerned with this effluent (e.g., the rainwater flowing through the debris filled waste container) that may take unwanted material from the debris with the effluent. Placing waterproof liners within the containers can keep all the debris and liquid within the waste container but now the user must transport extra weight of rainwater, which could be significant and adds hauling costs and reduces hauling capacity and efficiency. There is a desire for a cost-effective solution to allow rainwater to flow through a waste container without likelihood of entraining significant material within such effluent.

A further issue with truck delivered waste containers of the prior art is the need reduce labor costs in the delivery and pick up of such containers. In operating a fleet of waste containers, the labor costs represent the key variable cost to the business.

There remains a need in the art to address the problems with the prior art systems discussed above in a cost effective efficient manner.

### SUMMARY OF THE INVENTION

One aspect of the present invention is directed to a cost effective, efficient waste container system providing hoisted, stacked, waste containers each with locking dump pivot, low profile protective feet and alignment members, and filtering drain.

One aspect of the present invention is directed to a method of retrofitting waste containers to include one or more of a locking dump pivot, low profile protective feet, and filtering drain.

One aspect of the present invention provides a hoisted waste container system comprising a truck that delivers and retrieves at least one container, the truck having a hoist for delivering, retrieving and dumping the at least one container and a pair of stanchions; and a first container having a steel body including a pair of side walls, a front end wall, a rear end wall, and flooring, wherein rear end wall has hinges and a latching member to create a door in a rearward end of the container; and a locking dump pivot comprising a pair of trunnions coupled to the side walls of the container configured to be received within a saddle in the pair of stanchions, wherein the locking dump pivot acts to secure the container to the truck and further the locking dump pivot acts as a pivot point for dumping of the container.

The hoisted waste container system according to one aspect of the invention may provide wherein the side walls include side sills and vertical support members, wherein the trunnions are welded to the side sills or vertical support members, and wherein the end walls include top chord members and the side walls include top chord members, wherein the side sills, vertical support members, and top chord members are tubular products.

The hoisted waste container system according to one aspect of the invention may provide wherein at least one stanchion includes a locking mechanism to secure the trunnions to the stanchions, and further including a pair of front stops near a front of a bed of the truck configured to engage one of the end walls of the container.

The hoisted waste container system according to one aspect of the invention may provide at least a second stackable container having a steel body including a pair of side walls, a front end wall, a rear end wall, and flooring, and foot and alignment members secured to the flooring, wherein the second stackable container is stackable on the first container, and wherein the foot and alignment members are adjacent the side wall and end wall of the first container to securely nest the second container to the first container preventing relative lateral and longitudinal movement of the stacked containers. The hoisted waste container system may further provide wherein each foot and alignment member includes a metal tubular base with a plastic or rubber shoe, and wherein a locking mechanism secures the nested containers together.

The hoisted waste container system according to one aspect of the invention may, further including a filtering drain in the flooring, wherein the filtering drain in the flooring is formed in a slot in the flooring and includes a metal screen supporting filter media.

One aspect of the present invention provides a hoisted stackable waste container system comprising: a truck that delivers and retrieves a plurality of stackable containers, the truck having a hoist for delivering and retrieving the stackable containers; and a plurality of containers, each container having a steel body including a pair of side walls, a front end wall, a rear end wall, and flooring, and foot and alignment members secured to the flooring, wherein a second stackable container is stackable on a first container, and wherein the foot and alignment members of the second stackable container are adjacent the side wall and end wall of the first container to securely nest the second container to the first container preventing relative lateral and longitudinal movement of the stacked containers.

One aspect of the present invention provides a method of retrofitting a hoisted waste container having a steel body including a pair of side walls, a front end wall, a rear end wall, and flooring, comprising the steps of adding one or more of
i) foot and alignment members secured to the flooring, wherein container is stackable on a lower container, and wherein the foot and alignment members of the container are adjacent the side wall and end wall of the lower container to securely nest the container to the lower container preventing relative lateral and longitudinal movement of the stacked containers; and
ii) a locking dump pivot comprising a pair of trunnions coupled to the side walls of the container configured to be received within a saddle in a pair of stanchions on an associated truck, wherein the locking dump pivot acts to secure the container to the truck and further the locking dump pivot acts as a pivot point for dumping of the container.

These and other aspects of the present invention will be clarified in the description of the preferred embodiment of the present invention described below in connection with the attached figures in which like reference numerals represent like elements throughout.

### BRIEF DESCRIPTION OF THE FIGURES

FIGS. 1 is a schematic illustration of a waste container with locking dump pivot according to one embodiment of the present invention with the container stored on a delivery truck.

FIGS. 2 and 3 are schematic illustrations of the waste container of FIGS. 1 being hoisted off of the delivery truck.

FIGS. 4 schematically shows the loading of the waste container of FIGS. 1 on the delivery truck.

FIGS. 5 are 6 are schematic illustrations of the waste containers of FIGS. 1 being pivoted by the delivery truck for dumping (with the door closed for clarity).

FIGS. 7 is a schematic illustration of the waste container according to one embodiment of the present invention on a delivery truck

FIGS. 8 is a schematic illustration of the pivot pins of the locking dump pivot of the waste container of FIGS. 1.

FIGS. 9 is a schematic diagram of the locking dump pivot of the waste container of FIGS. 1.

FIGS. 10 is a schematic illustration of the door of the waste container of FIGS. 1.

FIGS. 11 a schematic illustration of a foot, partially disassembled, of the waste container of FIGS. 1.

FIGS. 12A and 12B are schematic top plan and side elevation section views of a filtering drain in the waste container of FIGS. 1.

FIGS. 13 illustrates stops engaging the container as shown in FIGS. 4 with the stops at a front of the truck bed of the truck carrying the container of FIGS. 1.

FIGS. 14 is a schematic view of the stacking of the containers according to the present invention.

### DESCRIPTION OF THE PREFERRED EMBODIMENTS

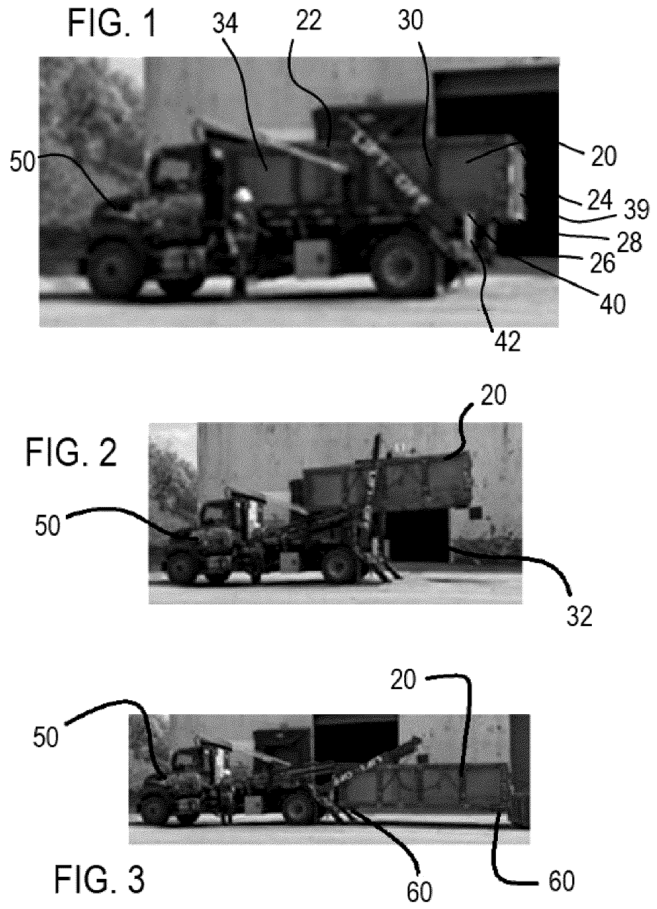

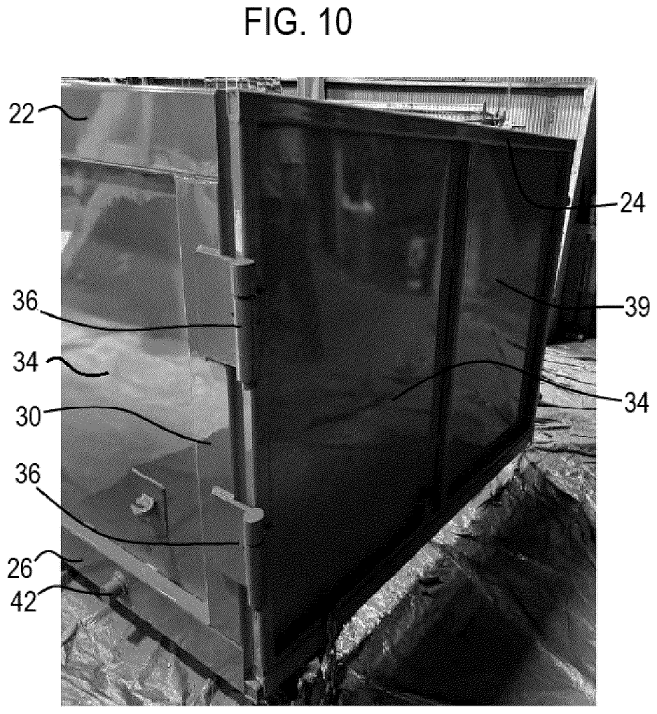

The present invention is directed to a cost effective, efficient waste container system 10 providing, generally, a pair of hoisted, stacked, waste containers 20 with locking dump pivot 40, low profile protective feet and alignment members 60, and filtering drain 80. FIGS. 1-14 show the container 20 of the present invention.

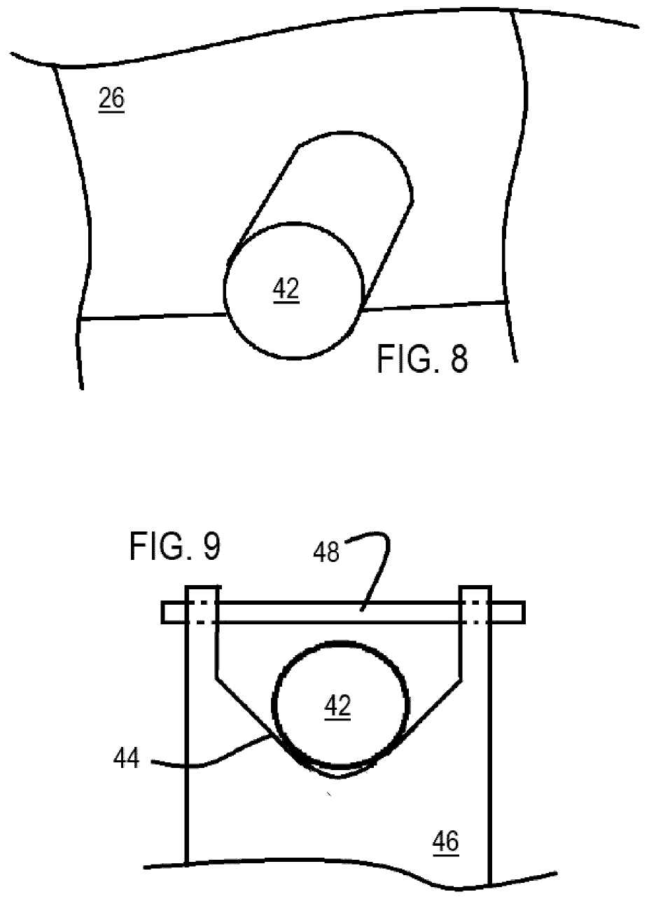

Each waste container 20 is an open top steel container 20, as best shown in FIGS. 7, having a pair of side tubular steel top chords 22 and pair of tubular steel end top chords 24 formed generally of tubular members. Each waste container 20 has a pair of tubular steel lower side sills 26 and pair of tubular steel end sills 28. Vertical support frame members 30 extend between each side top chord 22 and each lower side sill 26 and between each end top chord 24 and each end sill 28, also formed generally of tubular steel members. Floor frame members 32 shown in FIGS. 12A and 12B and also formed of tubular steel extend between the lower side sills 26. Steel plate members 34 form the side walls, end walls and flooring of the container 10.

The rear end wall has hinges 36 and latching member 38 to create a door 39 in the rearward end of the container 20. The door 39 may be chained into an open position for loading and for dumping of the container 20.

### Locking Dump Pivot 40

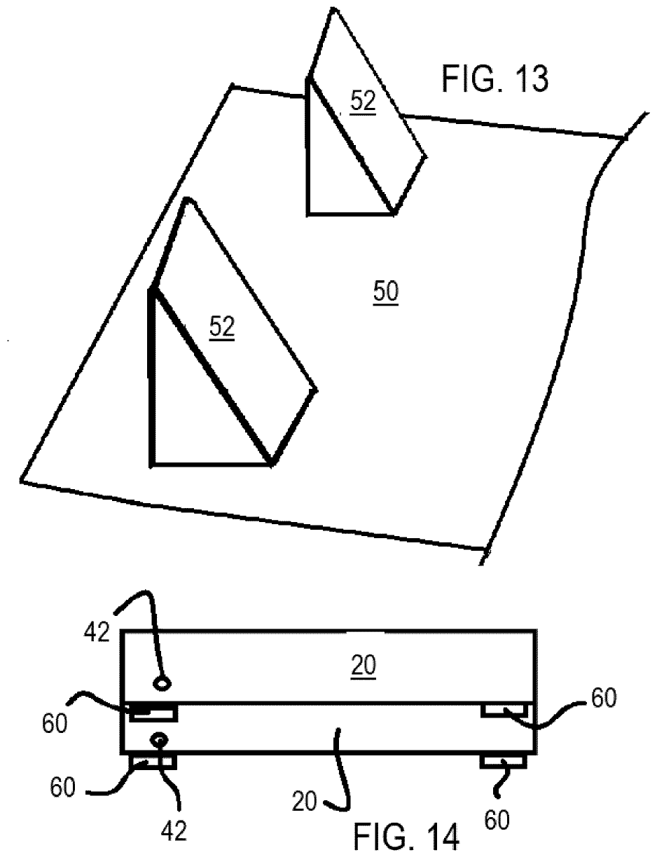

The waste containers 20 are stackable as schematically shown in FIGS. 14 and discussed below. At least the lower of the stackable waste containers 20 includes a locking dump pivot 40 comprising a pair of trunnions or pivot pins 42 welded to side sills 26 (or alternatively to a vertical support members 30) of the container 20.

The trunnions or pivot pins 42 are configured to be received within a receiving slot or saddle 44 in stanchions 46 on the associated truck 50 that delivers and retrieves the containers 20. A locking pin 48 in stanchion 46 above the position of the pin 42 in the saddle 44 secures the waste container 20. FIGS. 9 is a schematic diagram of the locking dump pivot of the waste container of FIGS. 1. The locking pin 48 is one of numerous examples of secure locking mechanisms. Pivoting latches that spring into a closed position (and that can be manually opened for unloading) is another example that is more complex but avoids separable pieces. The locking pin 48 may be designed to remain hanging onto or otherwise with the stanchion in the open position to avoid separable pieces (which could become lost).

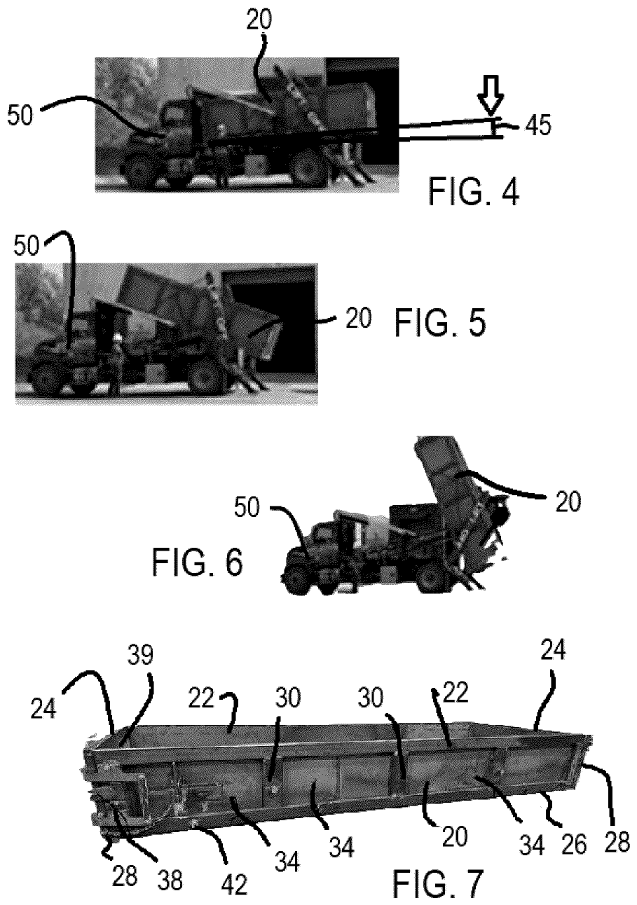

A pair of front stops 52 near the front of the bed of the truck 50, shown in FIGS. 13, are configured to engage the front-end wall of the container 20 which engaged position is shown in FIGS. 4 and positions the container 20 on the truck 50 so the pins 42 are lowered through a small angle 45 into the saddles 44 of the stanchions 46 with the hoist 54. The stops 52 have an angled face which positions the container 20 for the secure loading. After loading the stops 52 act as axial stops preventing forward movement of the container 20. The locking dump pivot 40 secures the container 20 to the truck 50 and prevents forward aft movement and vertical movement as well as excessive lateral movement. Lateral stops may also be used on the truck bed of the truck 50. The locking dump pivot 40 acts as a tie down securement mechanism for the container 20 and eliminates the need for timely tie down procedures.

In addition, to securing the container 20 to the truck 50, the locking dump pivot 40 acts as a pivot point for dumping or unloading of the container 20. With the door 39 opened and chained to an open position the truck 50 can lift the container 20 which will pivot about the locking dump pivot 40 for unloading of the container 20 at the relevant location. The side sill 26 positioning of the pivot pins 42 is a preferred location for pivoting the containers. FIGS. 5-6 show the pivoting of the containers 20 by the truck 50 about the pivot pins 42 in the stanchions 50 (although the figures show the door closed for clarity).

Existing containers 20 on hoist trucks 50 can be easily modified to include the locking dump pivot 40. The locking dump pivot 40 is a simple modification to an existing skip/lugger bin 20 by adding a trunnion 42 to both sides of the bin 20 near the bottom and near the tipping end. The truck 50 is modified to have a pair of stanchions 46 with saddles 44 on the rear of the hoist bed at the position of the trunnions 42 of a properly positioned bin 20. The positioning stops 52 are added to the bed to assure easy positioning of a bin 20 during loading. The locking dump pivot 40 allows the bin 20 to be dumped/tipped without the need for a chain, hook or cylinder, which allows for a steeper tipping degree while being a safer more stable tip or unload of the bin 20. Additionally, the locking dump pivot 40 locks the bin 20 to the hoist truck for secure transportation due to the locking pin 48 part of the saddle 44

### Low Profile Protective Feet and Alignment Members 60

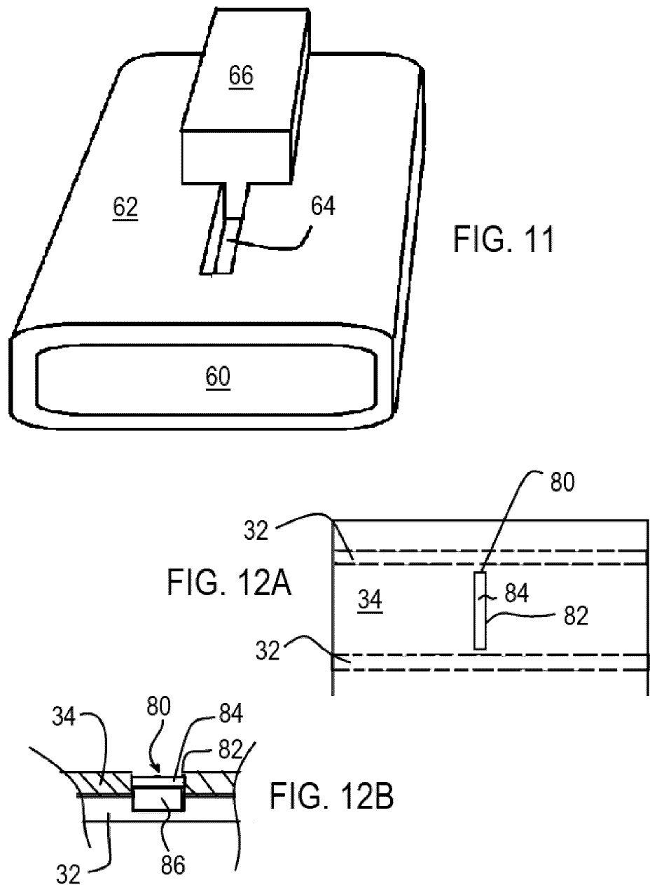

The waste container system 10 includes low profile protective feet and alignment members 60 on each container 20. FIGS. 11 a schematic illustration of a low profile protective foot and alignment member 60 (or foot 60), partially disassembled. The members 60 are formed of a tubular base or foot 62 with slot 64 and an H shaped rubber shoe 66 (or plastic or other protective material) secured therein. The tubular base 62 is welded to the plate member 34 forming the floor. The rubber shoe 66 minimizes marring of support surfaces like asphalt. The base 62 and separate rubber shoe 66 allows the member 60 to be easily repaired when the shoe 66 are worn as a new shoe 66 can be installed. The simple design of the member 60 is that the base or foot 62 is a steel tube or channel that is attached to the bin 22 normally by welding. The base 62 has a slot 64 that will hold the shoe 66 which is a protective material such as rubber or plastic that is between the foot or base 62 and the surface. The shoe 66 may be an extruded rubber member formed like a letter H on its side with a smaller top leg, this design of the member 60 allows the shoe 66 to be installed or changed only with hammer.

The low profile protective feet and alignment members 60 on each container 20 also are positioned to act as alignment members when stacking containers 20 as schematically shown in FIGS. 14. Namely the alignment members 60 of an upper stackable container 20 are generally adjacent the top chord 22 and end chord 24 of the lower container 20 to securely nest the upper container 10 to the lower container 20. The engagement of the alignment members 60 of an upper stackable container 20 with the adjacent the top chord 22 and end chord 24 of the lower container 20 prevent lateral and longitudinal movement of the stacked containers 20.

The low profile protective feet and alignment members 60 will help protect the surface when the waste container 20 is placed down on the surface, such as asphalt or concrete or brick. This low profile protective feet and alignment members 60 will work on any metal waste container, such as a lugger box, skip box, roll-off, front load, rear load and any other steel container The low profile protective feet and alignment members 60 protect the surface (concrete, asphalt or brick) from scrapping, scuffing and chipping and the design also prevents steel from directly contacting the surface, which also will minimize or eliminate rust marks. An additional benefit is that low the profile protective feet and alignment members 60 provides sound mitigation and prevents a loud bang as waster container 20 is placed onto the surface, as such a loud bang can be unduly concerning to customers

Locking pins (not shown) can secure the nested containers 20 together with the pins extending through the top chord 22 and end chord 24 of the lower container 20 and the members 60 of the upper container 20. Other locking systems could also be implemented, such as J-pins through slots in the lower side sills 26 of the upper container 20 and through aligned slots in the top chord 22 of the lower container. The end chord 24 could similarly provide a pinning location. Locking pins may be secured to one of the bins to not be separable therefrom to minimize losses.

The stacking containers 10 may be a larger capacity container 20 as the lower container 20 and a lower capacity container as the upper container 20 of the stack. In practice, the stacking containers 10 may be a smaller capacity container 20 as the lower container 20 and a larger capacity container as the upper container 20 of the stack, as smaller capacity containers 20 are often used for disposal of dense materials. The stacking containers 20 allows a single operator and truck 50 to deliver and pick up two, three or even four separate containers 20 in a single run. Additionally, the ease of loading and unloading of the containers 20 allows the operator to easily shuffle the order of containers if desired. For example, consider an operator picking up a third filled container 20 that the operator feels should be placed on the bed of the truck 30. The stored containers 20 are quickly unloaded from the truck 50 and the third container 20 placed on the bed of the truck 50 with the other containers 20 then stacked on top. Having a single driver service several sites in a single trip is a large labor savings.

### Filtering Drain 80

The waste container 20 includes a filtering drain 80. FIGS. 12A and 12B are schematic top plan and side elevation section views of a filtering drain 80 in the waste container 20. The filtering drain 80 includes a slot 82 in a plate member 34 forming the floor between the frame members 32. The filtering drain 80 includes a removable metal screen 84 and a filtering media 86 supported thereby. The metal screen 84 prevents large particulates from flowing through the drain 80 and more significantly prevents debris tossed into the container from damaging the filter media 86. The removable metal screen may include slide latches that lock under the plate member 34 or other simple securement mechanism for attachment. The filter media 86 can be anything sufficient for preventing particulates flowing therethrough. Heavy duty filter material, such as sold under the HYDROBLOCK™ brand could form the filter media 86. Additionally foam or coir materials forming above grate inlet filter mats may also be used. The filtering drain 80 is configured to allow for replacing of the filtering drain should the filter media become blinded via the removable screen 82. The filter media 86 does not extend beyond the frame members 32 or feet 60. The filter media 86 may include a separate perforated metal housing (U shaped or channel member) welded around the slot 82 to provide support for the media 86.

The filtering drain 80 provides a simple passive filter system for dumpsters, bins and roll-off boxes 20. The filtering drain 80 captures particulates that may be part of, for example, the dry construction debris that was inside the dumpster 20, and prevent them mixing with rain water to prevent storm water runoff with suspended solids. Note that existing roll off boxes with lids are expensive and such lids are easily damaged and will only work if the lids are shut. Prior art solutions of plastics bag liners are labor intensive as the driver has to install on each load, and these are easily ripped if sharp material is placed into the dumpster, and these captures the rain water which then goes to the landfill making the load heaver, increasing the land fill wet to dry ratio and creating more leachate for the landfill to treat. Existing waste containers 20 have no storm water compliance, which is the current practice in over 90% of situation, and this negatively affects storm water management. The filtering drain 80 provides an elegant simple solution.

### Retrofitting

The present invention provides a method of retrofitting waste containers to include one or more of a locking dump pivot 40, low profile protective feet 60, and filtering drain 80.

An existing hoisted waste container may be retrofitted to include a locking dump pivot 40 by welding a pair of pivot pins 42 to suitable side wall elements, preferably the side sill elements or equivalent reinforced structure. This may require adding vertical support members 30 to the container 20 in the desired location. Stanchions 46 are welded onto an associated truck 50 whereby the pivot pins 42 are configured to be received within the receiving slot 44 in stanchions 46 on the associated truck 50. Again, the locking pin 48 in stanchion 46 above the position of the pin 42 in the slot 44 secures the waste container to the truck 50. A pair of front stops 52 are welded or otherwise attached to the truck bed in a position to engage the front end wall of the container and position the container 20 so the pins 42 are lowered a small angle 45 into the slots 44 of the stanchions 46 with the hoist 54. The locking dump pivot 40 secures the container 20 to the truck 50 and prevents forward aft movement and vertical movement as well as excessive lateral movement. Lateral stops may also be added to and used on the truck bed.

As noted above, in addition to securing the container 20 to the truck 50, the locking dump pivot 40 acts as a pivot point for dumping or unloading of the container 20, and this consideration should be used to position the pivots 40. With a door opened and chained to an open position, the truck 50 can lift the retrofitted container which will pivot about the locking dump pivot 40 for unloading of the container at the relevant location.

An existing waste container may be retrofitted to include the low profile protective feet and alignment members 60 on the container 20. The tubular bases 62 may be welded to the floor of the existing waste container 20. The rubber foot member 66 minimizes marring of support surfaces like asphalt. The base 62 and separate rubber member 66 allows the member 60 to be easily upgraded when the members 66 are worn as new members 66 can be installed.

An existing waste container may be retrofitted to include a filtering drain 80. A slot 82 is formed in the floor between frame members thereof. The filtering drain 80 includes a metal screen 84 and a filtering media 86 supported thereby. The filtering media 86 may have a separate perforated metal housing welded around the slot 82 and the screen formed as easily removable. The metal screen 84 prevents large particulates from flowing through the drain 80 and more significantly prevents debris tossed into the container from damaging the filter media 86. The filter media 86 can be anything sufficient for preventing particulates flowing therethrough as discussed above.

It is apparent that many variations to the present invention may be made without departing from the spirit and scope of the invention. The present invention is defined by the appended claims and equivalents thereto.

What is claimed is:

1. A hoisted waste container system comprising:
A truck that delivers and retrieves at least one container, the truck having a hoist for delivering, retrieving and dumping the at least one container and a pair of stanchions;
A first container having a steel body including a pair of side walls, a front end wall, a rear end wall, and flooring, wherein rear end wall has hinges and a latching member to create a door in a rearward end of the container; and a locking dump pivot comprising a pair of trunnions coupled to the side walls of the container configured to be received within a saddle in the pair of stanchions, wherein the locking dump pivot acts to secure the container to the truck and further the locking dump pivot acts as a pivot point for dumping of the container.

2. The hoisted waste container system according to claim 1, wherein the side walls include side sills and vertical support members, wherein the trunnions are welded to the side sills or vertical support members.

3. The hoisted waste container system according to claim 2, wherein the end walls include top chord members and the side walls include top chord members, wherein the side sills, vertical support members, and top chord members are tubular products.

4. The hoisted waste container system according to claim 1, wherein at least one stanchion includes a locking mechanism to secure the trunnions to the stanchions.

5. The hoisted waste container system according to claim 1, further including a pair of front stops near a front of a bed of the truck configured to engage one of the end walls of the container.

6. The hoisted waste container system according to claim 1, further including at least a second stackable container having a steel body including a pair of side walls, a front end wall, a rear end wall, and flooring, and foot and alignment members secured to the flooring, wherein the second stackable container is stackable on the first container, and wherein the foot and alignment members are adjacent the side wall and end wall of the first container to securely nest the second container to the first container preventing relative lateral and longitudinal movement of the stacked containers.

7. The hoisted waste container system according to claim 6, wherein each foot and alignment member includes a metal tubular base with a plastic or rubber shoe.

8. The hoisted waste container system according to claim 6, wherein a locking mechanism secures the nested containers together.

9. The hoisted waste container system according to claim 1, further including a filtering drain in the flooring.

10. The hoisted waste container system according to claim 9, wherein the filtering drain in the flooring is formed in a slot in the flooring and includes a metal screen supporting filter media.

11. A hoisted stackable waste container system comprising:
A truck that delivers and retrieves a plurality of stackable containers, the truck having a hoist for delivering and retrieving the stackable containers;
A plurality of containers, each container having a steel body including a pair of side walls, a front end wall, a rear end wall, and flooring, and foot and alignment members secured to the flooring, wherein a second stackable container is stackable on a first container, and wherein the foot and alignment members of the second stackable container are adjacent the side wall and end wall of the first container to securely nest the second container to the first container preventing relative lateral and longitudinal movement of the stacked containers.

12. The hoisted stackable waste container system according to claim 11, wherein each foot and alignment member includes a metal tubular base with a plastic or rubber shoe.

13. The hoisted stackable waste container system according to claim 11, wherein a locking mechanism secures the nested containers together.

14. The hoisted stackable waste container system according to claim 11, further including a filtering drain in the flooring.

15. The hoisted stackable waste container system according to claim 14, wherein the filtering drain in the flooring is formed in a slot in the flooring and includes a metal screen supporting filter media.

16. The hoisted stackable waste container system according to claim 11, wherein the hoist is for dumping the containers and the truck includes a pair of stanchions, wherein a rear end wall of each container has hinges and a latching member to create a door in a rearward end of each container; and a locking dump pivot comprising a pair of trunnions coupled to the side walls of the container configured to be received within a saddle in the pair of stanchions, wherein the locking dump pivot acts to secure the container to the truck and further the locking dump pivot acts as a pivot point for dumping of the container.

17. The hoisted stackable waste container system according to claim 16, wherein at least one stanchion includes a locking mechanism to secure the trunnions to the stanchions.

18. The hoisted stackable waste container system according to claim 11, further including a pair of front stops near a front of a bed of the truck configured to engage one of the end walls of the container.

19. A method of retrofitting a hoisted waste container having a steel body including a pair of side walls, a front end wall, a rear end wall, and flooring, comprising the steps of adding one or more of
i) foot and alignment members secured to the flooring, wherein container is stackable on a lower container, and wherein the foot and alignment members of the container are adjacent the side wall and end wall of the lower container to securely nest the container to the lower container preventing relative lateral and longitudinal movement of the stacked containers; and
ii) a locking dump pivot comprising a pair of trunnions coupled to the side walls of the container configured to be received within a saddle in a pair of stanchions on an associated truck, wherein the locking dump pivot acts to secure the container to the truck and further the locking dump pivot acts as a pivot point for dumping of the container.

20. method of retrofitting a hoisted waste container according to claim 19 further comprising the step of adding a filtering drain in the flooring.
